(19) United States
(12) Patent Application Publication
(10) Pub. No.: US 2025/0272376 A1
(43) Pub. Date: Aug. 28, 2025

(54) AUTHENTICATION METHOD AND SYSTEM

(71) Applicant: STMicroelectronics International N.V., Geneva (CH)

(72) Inventor: Frédéric Gouabau, Betton (FR)

(21) Appl. No.: 19/059,595

(22) Filed: Feb. 21, 2025

(30) Foreign Application Priority Data
Feb. 22, 2024 (FR) FR2401745

(51) Int. Cl. G06F 21/32; G06F 21/62

(52) U.S. Cl. CPC G06F 21/32; G06F 21/6218

(57) ABSTRACT

The present description concerns a method of authentication of a user, to a reader, using a system having the reader and an electronic device having a first biometric authentication procedure and a second authentication procedure. The method includes the following successive steps: using the first procedure to authenticate the user, if the authentication is a success, sending a first identifier associated with the first procedure to the reader to authenticate the user, and if the authentication is not a success, using the second procedure to authenticate the user to the reader by sending a second identifier associated with the second procedure to the reader.

### CROSS-REFERENCED TO RELATED APPLICATIONS

This application claims the priority benefit of French Patent Application No. 2401745, filed on Feb. 22, 2024, entitled “Procédé d'authentification,” which is hereby incorporated herein by reference to the maximum extent allowable by law.

### TECHNICAL FIELD

The present disclosure generally concerns security methods and systems, such as a security system for a structure such as a building, and more particularly relates to authentication of a person to a reader.

### BACKGROUND

Information technology (IT) security currently is a major industrial issue. In particular, authentication methods enabling a system to verify the legitimacy of an access request issued by an entity, such as a user or another computer system, in order to authorize access to resources of the system, are constantly being improved.

It would be desirable to be able to improve, at least partly, certain aspects of existing security systems and authentication procedures.

### SUMMARY

There exists a need for a higher-performance security system.

There exists a need for a higher-performance authentication method.

There exists a need for a higher-performance security system for the access to a building.

An embodiment overcomes all or part of the disadvantages of known authentication methods.

An embodiment overcomes all or part of the disadvantages of known security systems.

An embodiment provides a security system using a plurality of authentication procedures, including at least a biometric authentication procedure.

An embodiment provides a security system easily adaptable to existing security systems.

An embodiment provides an authentication method easily adaptable to existing authentication methods.

An embodiment provides a method of authenticating a user, to a reader, using a system comprising the reader and an electronic device comprising a first biometric authentication procedure and a second authentication procedure, comprising the following successive steps:
A using the first procedure to authenticate the user to the electronic device;
B if the authentication of step A is a success, sending a first identifier associated with the first procedure to the reader to authenticate the user;
C if the authentication of step A is not a success, using the second procedure to authenticate the user to the reader by sending a second identifier associated with the second procedure to the reader.

Another embodiment provides a system comprising a reader and an electronic device, the electronic device comprising a first biometric authentication procedure and a second authentication procedure, the system being configured to implementing an authentication method comprising the following successive steps:
A using the first procedure to authenticate the user to the electronic device; B if the authentication of step A is a success, sending a first identifier associated with the first procedure to the reader to authenticate the user;
C if the authentication of step A is not a success, using the second procedure to authenticate the user to the reader by sending a second identifier associated with the second procedure to the reader.

According to an embodiment, the reader uses the first identifier or the second identifier to find out whether the user has been authenticated or not, the database being configured to associating at least two identifiers with the same user.

According to an embodiment, the reader transfers the first identifier or the second identifier to a database to find out whether the user has been authenticated or not.

According to an embodiment, during step C, the reader transfers the second identifier to the database, which indicates whether an operation of verification of a secret data element is necessary.

According to an embodiment, during step C, if the operation of verification of a secret data element is necessary, then the user uses an interface of the reader to deliver the secret data element.

According to an embodiment, the first biometric authentication procedure uses a biometric sensor.

According to an embodiment, the electronic device and the reader are configured to communicating with each other by a wireless communication.

According to an embodiment, the wireless communication is a near-field communication.

According to an embodiment, the user cannot identify themselves without having the device.

According to an embodiment, the method comprises, after step B, a step D of implementation of a secure communication session of the electronic device by the reader.

According to an embodiment, during step D, an application configured to implementing a secure communication is selected.

According to an embodiment, during step D, a secure communication session is opened.

According to an embodiment, during step D, the secure communication session is closed.

Another embodiment provides an electronic device configured to being the electronic device in the previously-described system.

According to an embodiment, this device is a card.

Another embodiment provides a database configured to being the database in the previously-described system, and associating at least two identifiers with a same user.

### BRIEF DESCRIPTION OF THE DRAWINGS

The foregoing features and advantages, as well as others, will be described in detail in the rest of the disclosure of specific embodiments given as an illustration and not limitation with reference to the accompanying drawings, in which:

FIG. 1 shows an embodiment of a security system; and

FIG. 2 shows a block diagram illustrating an implementation mode of an authentication method.

### DETAILED DESCRIPTION OF ILLUSTRATIVE EMBODIMENTS

Like features have been designated by like references in the various figures. In particular, the structural and/or functional features that are common among the various embodiments may have the same references and may dispose identical structural, dimensional and material properties.

For clarity, only those steps and elements which are useful to the understanding of the described embodiments have been shown and are described in detail.

Unless indicated otherwise, when reference is made to two elements connected together, this signifies a direct connection without any intermediate elements other than conductors, and when reference is made to two elements coupled together, this signifies that these two elements can be connected or they can be coupled via one or more other elements.

In the following description, where reference is made to absolute position qualifiers, such as “front”, “back”, “top”, “bottom”, “left”, “right”, etc., or relative position qualifiers, such as “top”, “bottom”, “upper”, “lower”, etc., or orientation qualifiers, such as “horizontal”, “vertical”, etc., reference is made unless otherwise specified to the orientation of the drawings.

Unless specified otherwise, the expressions “about”, “approximately”, “substantially”, and “in the order of” signify plus or minus 10%, preferably of plus or minus 5%.

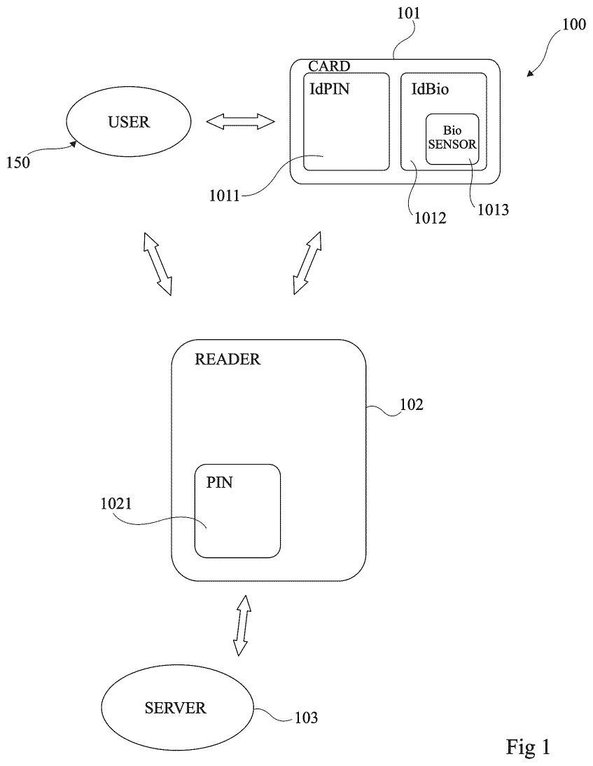

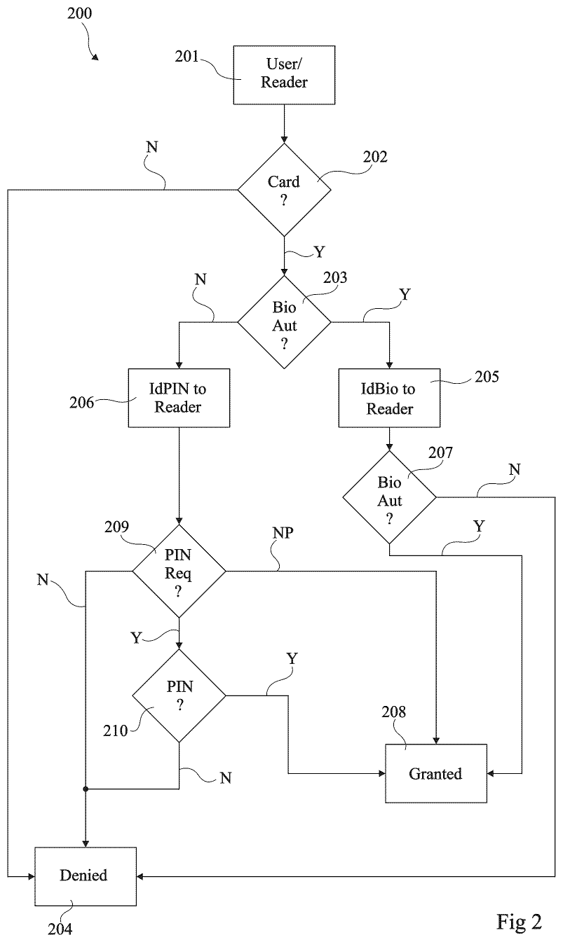

FIG. 1 shows, very schematically and in the form of blocks, an embodiment of a security system 100 configured to implementing a method of authentication of a natural person 150 wishing to access a structure. A detailed example of an implementation mode of an authentication method is described in relation with FIG. 2.

Security system 100 is used to control the accesses to a structure to be protected, such as a computer system or an infrastructure such as a building. More specifically, system 100 is used to ensure the legitimacy of an access request made by an entity 150 (USER), such as a natural person, called user 150 hereafter. A security system of the type of system 100 can enable to grant or to deny total, or partial, access to the structure to be protected.

System 100 comprises a personal electronic device 101 (CARD) assigned to each user 150, and a reader 102 (READER). Reader 102 is configured to interrogating a database 103 (SERVER), or server 103.

Electronic device 101 itself forms a first authentication factor. Indeed, without device 101, user 150 cannot authenticate themselves to access the structure. In other words, the electronic device is a “must carry” authentication factor, or “owned” authentication factor, to be able to authenticate oneself. Personal electronic device 101 is, for example, a card or a badge. According to another example, the electronic device is a connected object or a smartphone. Device 101 is assigned to a natural person, according to an example, to a single natural person. According to a preferred embodiment, the first authentication factor uses a secure communication to be implemented, such a communication is described hereafter.

According to an alternative embodiment, electronic device 101 enables to implement a second authentication factor using information known to user 150 only. To achieve this, electronic device 101 has two authentication procedures 1011 (IdPIN) and 1012 (IdBio).

Authentication procedure 1011 enables the holder of device 101 to authenticate to reader 102. Authentication procedure 1011 is associated with a first IdPIN identifier. In a first case, the simple fact of presenting the first identifier IdPIN enables the holder of device 101 to authenticate to reader 102. In a second case, where the security level is higher, authentication procedure 1011 enables the holder of device 101 to authenticate to reader 102 using a secret data element, such as a password or a personal identification number (PIN). To be implemented, authentication procedure 1011 uses, for example, reader 102 as described hereafter.

Authentication procedure 1012 enables the holder of device 101 to implement a biometric authentication to authenticate to device 101 itself. For this purpose, electronic device 101 is equipped with a biometric sensor 1013. According to a preferred embodiment, biometric sensor 1013 is a digital fingerprint sensor. According to a variant, biometric sensor 1013 is any other type of stand-alone biometric sensor, such as a retinal recognition sensor or a face recognition sensor. Biometric authentication procedure 1012 is associated with a second identifier IdBIO.

In other words, electronic device 101 comprises two virtual cards 1011 and 1012, both configured to authenticating the holder of device 101 by different authentication procedures. Virtual card 1011 is associated with the first identifier IdPIN, and virtual card 1012 is associated with the second identifier IdBIO.

Electronic device 101 further comprises a communication interface or circuit, not shown in FIG. 1, enabling it to interact with reader 103. According to an embodiment, the communication interface is a wireless communication circuit, such as for example a module configured to implementing a near-field communication (NFC). According to a preferred embodiment, the communication circuit is configured to implementing a near-field communication in accordance with the ISO/IEC 14443 standard.

Reader 102 is an electronic device configured to cooperating with electronic device 101 to authenticate the user 150 of device 101. According to an example, reader 102 is a portable reader, an access terminal to the structure to be protected, such as a secure door, etc.

Reader 102 is, for example, equipped with an interface 1021 enabling a device 101 to implement its authentication procedure 1011 when an authentication by addition of secret data is required. According to an example, interface 1021 is a keyboard or a touch screen.

Reader 102 further comprises a communication interface, not shown in FIG. 1, enabling it to interact with device 101. According to an embodiment, the communication circuit is a wireless communication circuit, such as for example a module configured to implementing a near-field communication (NFC). According to a preferred embodiment, the communication c circuit is configured to implementing a near-field communication according to the ISO/IEC 14443 standard. According to a preferred embodiment, the communication interface enables reader 102 and device 101 to implement a secure communication considered as reliable, in which no communication error is committed. The purpose of secure communication is for reader 102 to authenticate device 101 with a cryptographic protocol of verifier/prover type. Further, the secure session ensures that all the data received by reader 102 originate from the device 101 that it has authenticated.

Reader 102 further comprises an access to database 103. According to an example, reader 102 is coupled to the database by a wired link, secure or not.

Database 103 stores all the identifiers of natural persons owning electronic devices of the type of electronic device 101, as well as, for each identifier, data indicating whether the access to the structure protected by the system is authorized or not to the user. In other words, if natural persons, that is, users, can authenticate using at least two authentication procedures, database 103 stores at least two identifiers associated with the same user.

In addition, database 103 stores for each first identifier IdPIN information indicating whether the use of a secret data element is required to implement the authentication by the first authentication procedure 1011. According to an example, this information may define time slots during which the use of a secret data element is required, or parts of the structure for which the use of a secret data element is required.

The operation and the advantages of system 100 are described in relation with FIG. 2.

FIG. 2 is a flowchart illustrating an implementation mode of an authentication method 200 using the system 100 described in relation with FIG. 1.

At an initial step 201 (User/Reader), a user of the type of the user 150 described in relation with FIG. 1 wishes to have access to a structure protected by the system 100 of FIG. 1. For this purpose, user 150 is brought into contact with the reader 102 of system 100. According to a practical example, when user 150 is a natural person and the structure to be protected is a building or part of a building, at this step, user 150, for example, faces a reader at a door of the building.

At a step 202 (Card?), following step 201, the first authentication factor of the system is implemented. In other words, user 150 must present device 101 to be able to begin the authentication process with reader 102. If user 150 is in possession of device 101 (output Y of block 202), the next step is step 203 (Bio Aut?), otherwise (output N of block 202), the next step is a step 204 (Denied).

At step 204, user 150 does not present the first authentication factor, that is, the “must carry” authentication factor, the access to the structure is thus impossible for them.

At step 203, user 150 has implemented the first authentication factor, and now has to implement the second authentication factor to carry on the authentication method. As mentioned previously, the second authentication factor may be implemented by the two authentication procedures 1011 and 1012, or virtual cards 1011 and 1012. According to an embodiment, authentication procedure 1012 is implemented first.

To achieve this, the user implements a step of authentication to device 101 by using biometric sensor 1013. If this authentication step is a success (output Y of block 203), the next step is a step 205 (IdBio to Reader). Otherwise (Output N of block 203), the next step is a step 206 (IdPIN to Reader) where the second authentication procedure 1011 is implemented.

At step 205, the authentication of user 150 with device 101 is a success, whereby device 101 can initiate a communication with reader 102 to transmit the identifier IdBIO associated with virtual card 1012.

According to an example, device 101 and reader 102 can communicate with each other securely, for example by starting a secure communication session. The use of such a secure session enables device 101 and reader 102 to exchange data reliably. If device 101 or reader 102 receives data which do not originate from a secure session, one or the other may consider that these data are unreliable and not use them. To resort to a secure session, device 101 and reader 102 may implement a secure protocol, for example the secure protocol known under trade name Calypso. According to a preferred example, an authentication method implemented at step 202 comprises the following successive steps:
Selection, by device 101 and reader 102, of a software application configured to implementing the secure protocol;
Opening of a secure communication session;
Exchange, optionally, of one or a plurality of secret data elements; and
Closing of the secure communication session.

Once reader 102 has received the IdBIO identifier, reader 102 sends the related data to database 103 so that a decision can be made. It is also possible for reader 102 to store the IdBIO identifiers which have already been previously accepted.

At a step 207 (Bio Aut?), successive to step 205, a verification in database 103 is directly carried out to search for an access authorization associated with the IdBIO identifier. No further verification is here carried out, indeed, user 150 has already implemented a method of identification to device 101 at step 203. If the IdBIO identifier has an authorization to access database 103 (output Y of block 207), the next step is step 208 (Granted). Otherwise (output N of block 207), the next step is step 204, where the access to the structure is denied to user 150.

At step 208, user 150 is authorized to access the structure.

At step 206, the first authentication procedure 1011 has not worked, the second authentication procedure 1012 is thus here implemented. The IdPIN identifier is thus transmitted to reader 102. According to an embodiment, like the IdBIO identifier at step 205, the IdPIN identifier is transmitted securely, for example by using a secure session.

At a step 209 (PIN Req?), a verification in database 103 is directly performed to search for an access authorization associated with the IdBIO identifier. This access authorization may be direct, like the authorization associated with the IdBIO identifier, or may be granted only after verification of a secret data element. If database 103 indicates that the IdPIN identifier has a direct authorization (output NP of block 209), the next step is step 208 of authorization of the access to the structure. If database 103 indicates that the verification of a secret data element is required (output Y of block 209), then the next step is step 210 (PIN?). Finally, if the database indicates that the IdPIN identifier has no access authorization (output N of block 209), then the next step is step 204 of denial of the access to the structure.

At step 210, successive to step 206, database 103 has indicated that the verification of a secret data element is required to authorize the access to the structure. User 150 implements the second authentication procedure 1011 by using, for example, reader 102 to deliver the secret data element associated with the IdPIN identifier. According to an example, user 150 implements interface 1021 to enter a password or a PIN code. According to an example, reader 102 uses database 103 to verify the secret data element delivered by user 150.

If user 150 delivers the correct secret data element (output Y of step 210), the next step is step 208 of access to the structure.

If user 150 does not deliver the correct secret data element (output N of step 210), the next step is step 204, of denial of the access to the structure.

An advantage of this embodiment is that it enables to securely authenticate a user. Indeed, a user having had one of its identifiers sent to the database has necessarily had to implement at least two authentication factors, the first factor being to possess a device of the type of device 101, and the second factor being biometric information or the knowing of a secret data element.

Another advantage of this embodiment is that it enables a same person to be identified with a plurality of different identifiers, each derived from specific authentication procedure. A database comprising a single identifier associated with a user would only need an update to add a second identifier to a same user, and a reader associated with this database would need no update. Thus, another advantage of this embodiment is that it can use existing readers.

Various embodiments and variants have been described. Those skilled in the art will understand that certain features of these various embodiments and variants may be combined, and other variants will occur to those skilled in the art.

Finally, the practical implementation of the described embodiments and variants is within the abilities of those skilled in the art based on the functional indications given hereabove.

What is claimed is:

1. A method of authenticating a user to a reader, using a system comprising the reader and an electronic device having a first virtual card and a second virtual card configured to authenticate the user, the method comprising:
(A1) first using, by the first virtual card, a first biometric authentication procedure to attempt to authenticate the user to the electronic device;
(B) in response to the authentication of step (A1) being successful, sending, by the first virtual card, a first identifier associated with the first biometric authentication procedure to the reader to authenticate the user;
(A2) second using, by the first virtual card, the first biometric authentication procedure to attempt to authenticate the user to the electronic device; and
(C) in response to the authentication of step (A2) not being successful, using, by the second virtual card, a second authentication procedure to authenticate the user to the reader, by sending a second identifier associated with the second authentication procedure to the reader.

2. The method according to claim 1, further comprising using, by the reader, the first identifier or the second identifier to determine whether the user has been authenticated or not.

3. The method according to claim 2, further comprising:
associating, by a database, at least two identifiers with a same user; and
transferring, by the reader, the first identifier or the second identifier to the database to determine whether the user has been authenticated or not.

4. The method according to claim 3, further comprising, during step (C):
transferring, by the reader, the second identifier to the database; and
indicating, by the database, whether a verification operation of a secret data element is needed.

5. The method according to claim 4, further comprising, during step (C), in response to the verification operation of the secret data element being needed, using, by the user, an interface of the reader to deliver the secret data element.

6. The method according to claim 1, further comprising using, by the first virtual card, a biometric sensor in the first biometric authentication procedure.

7. The method according to claim 1, further comprising communicating, by the electronic device and the reader, with each other by a wireless communication.

8. The method according to claim 7, wherein the wireless communication is a near-field communication.

9. The method according to claim 1, wherein the user cannot authenticate to the reader without possessing the electronic device.

10. The method according to claim 1, further comprising, after step (B), step (D) implementing, by the reader, a secure communication session with the electronic device.

11. The method according to claim 10, further comprising, during step (D), selecting an application to implement a secure protocol.

12. The method according to claim 10, further comprising, during step (D), opening the secure communication session.

13. The method according to claim 12, further comprising, during step (D), closing the secure communication session.

14. A system for authenticating a user to a reader, the system comprising:
the reader; and
an electronic device comprising a first virtual card and a second virtual card configured to authenticate the user, wherein the system is configured to:
(A) use, by the first virtual card, a first biometric authentication procedure to attempt to authenticate the user to the electronic device;
(B) in response to the authentication of (A) being successful, send, by the first virtual card, a first identifier associated with the first biometric authentication procedure to the reader to authenticate the user; and
(C) in response to the authentication of (A) not being successful, use, by the second virtual card, a second authentication procedure to authenticate the user to the reader by sending a second identifier associated with the second authentication procedure to the reader.

15. The system according to claim 14, wherein the reader is configured to use the first identifier or the second identifier to determine whether the user has been authenticated or not.

16. The system according to claim 14, wherein the first virtual card is configured to use a biometric sensor in the first biometric authentication procedure.

17. The system according to claim 14, wherein the electronic device and the reader are configured to communicate with each other by a wireless communication.

18. The system according to claim 14, further comprising a database, wherein:
the database is configured to associate at least two identifiers with a same user; and
the reader is configured to transfer the first identifier or the second identifier to the database to determine whether the user has been authenticated or not.

19. An electronic device comprising:
a communications interface;
a first virtual card; and
a second virtual card configured to authenticate a user;
wherein the first virtual card is configured to:
use a biometric authentication procedure to attempt to authenticate the user to the electronic device; and
in response to the biometric authentication procedure being successful, send, via the communication interface, a first identifier associated with first biometric authentication procedure to a reader to authenticate the user; and
wherein the second virtual card is configured to, in response to the biometric authentication procedure not being successful, use a second authentication procedure to authenticate the user to the reader by sending, via the communication interface, a second identifier associated with the second authentication procedure to the reader.

20. The electronic device according to claim 19, wherein the electronic device is a personal card.
